(19) United States
(12) Patent Application Publication
(10) Pub. No.: US 2013/0165540 A1
(43) Pub. Date: Jun. 27, 2013

(54) Porous Calcium Phospate Granules and Methods of Making and Using the Same

(71) Applicant: SKELETAL KINETICS, LLC, Cupertino, CA (US)

(72) Inventors: David C. Delaney, Capitola, CA (US); Sahil Jalota, Santa Clara, CA (US)

(73) Assignee: SKELETAL KINETICS, LLC, Cupertino, CA (US)

(21) Appl. No.: 13/724,493

(22) Filed: Dec. 21, 2012

Related U.S. Application Data
(60) Provisional application No. 61/580,152, filed on Dec. 23, 2011.

(51) Int. Cl. C08J 9/00; C01B 25/32

(52) U.S. Cl. CPC C08J 9/0066; C01B 25/32
USPC 521/85; 521/50; 423/305

(57) ABSTRACT

Porous calcium phosphate granules and methods of making the same are provided. Embodiments of the methods include producing a solid spherical granule precursor that includes: (i) a calcium phosphate component; and (ii) a porogen component; and (b) removing the porogen component from the solid spherical granule precursor to produce a spherical porous calcium phosphate granule. Granules of the invention find use in a variety of different applications.

### CROSS-REFERENCE TO RELATED APPLICATIONS

Pursuant to 35 U.S.C. §119 (e), this application claims priority to the filing dates of: U.S. Provisional Patent Application Ser. No. 61/580,152 filed on Dec. 23, 2011; the disclosure of which application is herein incorporated by reference.

### INTRODUCTION

Autologous bone harvested from the patient's own bone is the gold standard bone substitute for repairing large bone defects. However, the amount of autologous bone harvestable from a patient is limited and the bone subtraction itself poses significant health risks and results in loss of structural integrity of the remaining bone.

Developments in tissue engineering have provided synthetic implants, for instance in the form of scaffold materials, which allow attachment of bone cells and ingrowth of new bone tissue and subsequent deposition of new bone mineral. The synthetic materials may either be grafted ex vivo with bone cells prior to implantation or may be implanted as naked scaffolds that attract bone cells from the periphery to the site of the implant.

Recent advances in tissue engineering have produced a variety of valuable scaffold materials. Calcium phosphates such as hydroxyapatite (HA; the mineral phase of bone), biphasic calcium phosphate (BCP) and α- or β-tricalcium phosphate (TCP) are known to possess both osteoconductive (bioactive) as well as osteoinductive properties and provide very suitable scaffold materials. The bioactive nature of calcium phosphates allows them to function as a template for new bone formation by osteogenic cells through deposition of new mineral material at the scaffold's surface and is an important feature of the scaffold material. The osteoinductive nature of calcium phosphates is a qualitative feature, i.e. the capacity to induce the development of the new bone tissue, thereby enhancing the rate of deposition of new mineral depends on various material parameters. Bone induction is generally defined as the mechanism by which a mesenchymal tissue is induced to change its cellular structure to become osteogenic.

In general, porous calcium phosphate materials have been found to exhibit osteoinductivity. For instance, Yamasaki et al., in Biomaterials 13:308-312 (1992), describe the occurrence of heterotopic ossification (formation of new bone in tissue that do not normally ossify) around porous hydroxyapatite ceramic granules, but not around dense granules. The porous granules discussed in this paper ranged in size from 200 to 600 μm, and had a continuous and interconnected microporosity of pores ranging in diameter from 2 to 10 μm.

### SUMMARY

Porous calcium phosphate granules and methods of making the same are provided. Embodiments of the methods include producing a solid spherical granule precursor that includes: (i) a calcium phosphate component; and (ii) a porogen component; and (b) removing the porogen component from the solid spherical granule precursor to produce a spherical porous calcium phosphate granule. Granules of the invention find use in a variety of different applications.

### BRIEF DESCRIPTION OF THE FIGURES

FIG. 1 provides X-Ray diffraction analysis for (a) commercial β-TCP powder and (b) synthesized β-TCP granules in accordance with an embodiment of the invention.

FIG. 2 provides FTIR patterns for (a) commercial β-TCP powder and (b) synthesized β-TCP granules in accordance with an embodiment of the invention.

FIG. 3 provides SEM micrographs of beads at low magnification (3a, 3b) demonstrating the full bead morphology; low magnification of the cracked bead surface (3c,3d); and high magnification micrographs of cracked bead surface (3e,3f).

### DETAILED DESCRIPTION

Porous calcium phosphate granules and methods of making the same are provided. Embodiments of the methods include producing a solid spherical granule precursor comprising: (i) a calcium phosphate component; and (ii) a porogen component; and (b) removing the porogen component from the solid spherical granule precursor to produce a spherical porous calcium phosphate granule. Granules of the invention find use in a variety of different applications.

Before the present invention is further described, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Methods recited herein may be carried out in any order of the recited events which is logically possible, as well as the recited order of events.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

All publications mentioned herein are incorporated herein by reference to disclose and describe the methods and/or materials in connection with which the publications are cited.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

### Porous Calcium Phosphate Granules and Methods of Making the Same

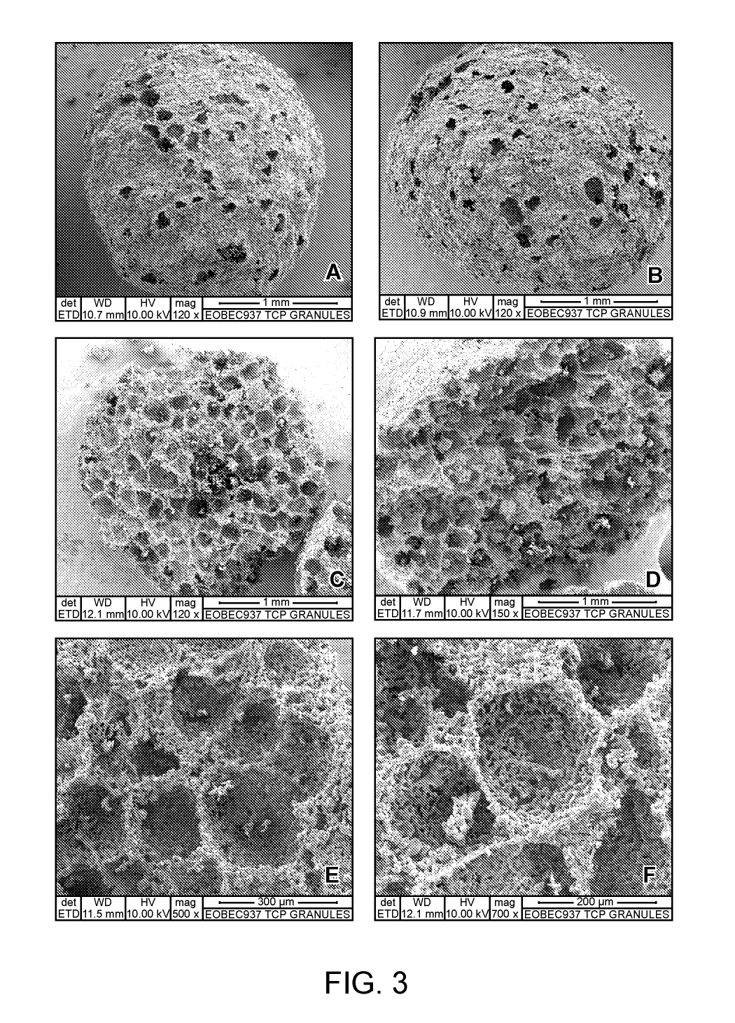

As summarized above, porous calcium phosphate granules and methods of the making the same are provided. The granules produced by methods of the invention are substantially spherical and include both macropores and micropores. As the granules are substantially spherical, they may be spheres or sphere-like in their shape, i.e., they are spheroidal. FIG. 3 is illustrative of these spheroidal or substantially spherical characteristics.

As the granules include both micropores and macropores, they are microporous and macroporous. Micropores present in the granules have diameters that are 20 microns or less, where the average diameter of the micropores may range from 0.1 to 20 microns, such as 1 to 10 microns. Macropores present in the granules have diameters that are 100 microns or greater, where the average diameter of the macropores may range from 100 to 750 microns, such as 100 to 450 microns. The outer surface of the granules is characterized by being substantially more microporous than macroporous. The total porosity of the granules may vary, and in some instances is 60% or greater, such as 65% or greater, ranging in some instances from 70 to 90%, such as 75 to 85%, e.g., 77.5 to 82.5%, including 80%, as determined by mercury porosimetry.

The porous calcium phosphate granules may have varying diameters. In some instances, the granules have diameters of 1 mm or longer, such as 1.5 mm or longer. In some embodiments, the granules have diameters ranging from to 1 to 5 mm, such as 1.5 to 4 mm, e.g., 2 to 3 mm. The mass of the granules may also vary, ranging in some instances from 1 to 5 mg, such as 2 to 5 mg and including 3 to 4 mg.

As summarized above, the granules are calcium phosphate granules. As such, they are made up of one or more types of calcium phosphate minerals. In some instances, the granules are substantially pure with respect to a single type of calcium phosphate mineral. As the granules are substantially pure with respect to a single type of calcium phosphate mineral in these embodiments, the single type of calcium phosphate mineral will make up 99.5% or more, such as 99.75% or more, including 99.99% or more of the total mass of the granule. In yet other embodiments, the granules may include two or more different types of calcium phosphate minerals, e.g., two different types of calcium phosphate minerals. In such instances, the granules will be substantially pure with respect to the two or more calcium phosphate minerals, such that the two or more calcium phosphate minerals will make up 99.5% or more, such as 99.75% or more, including 99.99% or more of the total mass of the granule. Calcium phosphate minerals that are present in the granules may vary, wherein calcium phosphate minerals of interest include those calcium phosphate minerals having a calcium-to-phosphate ratio ranging from 1.5 to 1 to 1.67 to 1. Specific calcium phosphate minerals of interest include but are not limited to: β-tricalcium phosphate, hydroxyapatite, etc.

Aspects of the invention include methods of making β-tricalcium phosphate granules, e.g., as described above. In certain embodiments, the methods include producing a solid spherical granule precursor that includes: (i) a calcium phosphate component; and (ii) a porogen component; and then removing the porogen component from the solid spherical granule precursor to produce a spherical porous calcium phosphate granule.

The solid spherical granule precursor is a substantially spherical object, e.g., as described above. The solid spherical granule precursors have diameters ranging from to 1 to 5 mm, such as 1.5 to 4 mm, e.g., 2 to 3 mm. The mass of the granules may also vary, ranging in some instances from 1 to 5 mg, such as 2 to 5 mg and including 3 to 4 mg. The solid spherical granule precursors include both a calcium phosphate component and a porogen component. The calcium phosphate component includes one or more calcium phosphates, e.g., as described above. Accordingly, specific calcium phosphate minerals of interest include but are not limited to: β-tricalcium phosphate, hydroxyapatite, etc.

Porogen components present in the granule precursors may include one or more different porogens, as desired. The term “porogen” as used herein, refers to a chemical compound that is included in the precursor granule produced e.g., as described in greater detail below. Upon subjection of the precursor granule to elevated, e.g., sintering, temperatures, the porogen is removed from the precursor granule to leave a porous granule, e.g., as described above. A porogen may be viewed as an entity that reserves space in the precursor granule while the precursor granule is being prepared, following which time the porogen is removed to result in porosity in final granule product. In this way porogens provide latent pores in the solid precursor granule.

Porogen materials of interest are those materials which may be removed from the precursor granule by subjecting the precursor granule to elevated temperatures to produce the final porous granule, e.g., as described above. Porogen materials of interest include, but are not limited to: organic polymers, such as chitosan, poly(ethylene oxide), poly (lactic acid), poly(acrylic acid), poly(vinyl alcohol), poly(urethane), poly(N-isopropyl acrylamide), poly(vinyl pyrrolidone) (PVP), poly (methacrylic acid), poly(p-styrene carboxylic acid), poly(p-styrenesulfonic acid), poly(vinylsulfonicacid), poly(ethyleneimine), poly(vinylamine), poly(anhydride), poly(L-lysine), poly(L-glutamic acid), poly(gamma-glutamic acid), poly(carprolactone), polylactide, poly(ethylene), poly(propylene), poly(glycolide), poly(lactide-co-glycolide), poly(amide), poly(hydroxylacid), poly(sulfone), poly(amine), poly(saccharide), poly(HEMA), poly(anhydride), collagen, gelatin, glycosaminoglycans (GAG), poly (hyaluronic acid), poly(sodium alginate), hyaluronan, agarose, polyhydroxybutyrate (PHB), and combinations thereof.

In the solid precursor granules, the porogen materials may be present as substantially spherical sub-components. The diameter of the porogen sub-components may vary, ranging in some instances from 50 to 500 microns, such as 100 to 400 microns. As discussed above, the solid precursor granules include both a calcium phosphate component and a porogen component. The disparate amounts of each component in the precursor granules may vary.

The solid precursor granules, e.g., as described above, may be prepared using any convenient protocol. In some instances, the precursor granules are prepared by combining a calcium phosphate powder, a porogen and a liquid vehicle to produce a liquid precursor composition; and making a solid spherical granule precursor from the liquid precursor composition. In these embodiments, the liquid precursor composition may be prepared using any convenient protocol. In some instances, the protocol includes combining one or more calcium phosphate powders (particulate compositions, e.g., having a particle sizes ranging from 1 to 50 microns, such as 2 to 30 microns) with one or more porogens and a liquid vehicle. The liquid vehicle may vary, and in some instances is an aqueous liquid component. Generally, the liquid may be pure water or water that includes one or more solutes of interest, e.g., salts, buffering agents, active agents, etc., as desired.

As reviewed above, when employing a liquid precursor composition, solid spherical granule precursors are prepared from the liquid precursor composition. While any convenient protocol may be employed to produce solid spherical precursor granules from the liquid precursor composition, in some instances the liquid precursor includes an initially soluble polymeric component which is insolubilized in the presence of an insolubilizing agent to produce solid precursor granules. Of interest are polymeric components which become insoluble in the presence of a salt of a divalent cation, e.g., calcium or magnesium salts, such as calcium chloride, magnesium chloride, etc. Polymeric components of interest include, but are not limited to, water-soluble alginic salts, e.g., sodium alginate, etc. Where such liquid precursor compositions are employed, the calcium phosphate component may be present in amounts ranging from 2 to 20 wt %, such as 5 to 10 wt %, including 6 to 8 wt %. The porogen compound may be present in amounts ranging from 1 to 10 wt %, such as 2.5 to 7.5 wt %, including 3 to 4 wt %. The polymeric component may be present in amount ranging from 0.5 to 2.5 wt %, such as 0.75 to 1.25 wt %.

In some instances, solid substantially spherical precursors are produced by dropping a liquid precursor composition, e.g., as described above, into a liquid that includes an insolubilizing agent. For example, where the precursor liquid includes a water-soluble alginic salt, the liquid may be dropped into a solution of a salt of divalent cation, such as calcium chloride solution. In such instances, the molarity of the salt solution will be sufficient to insolubilize the polymeric component, e.g., water-soluble alginic acid. In some instances, the molarity of the salt solution may range from 80 to 120 mM, such as 90 to 110 mM, e.g., 100 mM. The liquid precursor may be dropped into the solution at a rate sufficient to produce solid granule precursors of the desired shape and size. Any convenient protocol may be employed, including manual and automated protocols, as desired.

Following solidification of the liquid precursor composition into solid granule precursors, e.g., by insolubilizing a polymeric component such as described above, the resultant solid granule precursors may be separated from the liquid in which they are present and washed, as desired. Any free water may then be removed from the resultant granules. Water may be removed using any convenient protocol, such as maintaining at elevated temperatures, lyophilization, etc., as desired.

The porogen component is then separated from the dried precursor granules to produce the desired product porous calcium phosphate granules. The porogen component (as well as polymer component (when present)) may be removed from the precursor granules using any convenient protocol. In some instances, the granules are subjected to elevated temperature conditions, e.g., sintering conditions, sufficient to remove the porogen component from the precursor granules. In some instances, the precursor granules are subjected to a temperature of 750° C. or greater (e.g., 1000° C. or greater, 1100° C. or greater, 1200° C. or greater) for a period of time of 1 hour longer (e.g., 5 hours or longer, 7 hours or longer, 8 hours or longer). Where desired, a ramped sintering protocol may be employed, in which the precursor granules are subjected to a series of increasing and then decreasing temperatures, with the granules being maintained at given temperatures in the ramp cycle for a defined period of time, which may be 1 hour longer, e.g., 5 hours or longer. An example of such a ramped sintering protocol is:

| | |
|---|---|
| Room temperature to 110° C. | 10 hours |
| 110° C. to 250° C. | 12 hours |
| 250° C. to 500° C. | 9 hours |
| 500° C. to 1300° C. | 9 hours |
| 1300° C. hold | 9 hours |
| 1300° C. to room temperature | 9 hours |

The above protocol results in the production of porous calcium phosphate granules, e.g., as described above. In some instances, the protocol is employed to produce compositions that include a plurality of porous calcium phosphate granules in which the composition is highly uniform with respect to the nature of the granules. As such, protocols as described herein may be used to produce compositions of porous calcium phosphate granules that have a narrow size distribution with respect to the calcium phosphate granules. By narrow size distribution is meant that the standard deviation of the granules that make up the composition (e.g., as determined using the Horiba LA-300 laser diffraction particle sizer (Version 3.30 software for Windows 95) (Irvine, Calif.)) is 4.0 or less, and in certain embodiments is 3.0 or less, e.g., and may be 2.5 or less, including 2.0 μm or less.

Granules and compositions, e.g., as described above, find use in a variety of different applications.

### Utility

Compositions of porous calcium phosphate granules produced, e.g., as described above, find use in a variety of different applications, where such applications may include medical, research and industrial applications. Medical applications of interest may vary greatly, and may or may not include combining the granules with one or more additional active components, such as active agents, autologous components, etc. Aspects of the invention include methods in which an amount of porous calcium phosphate granules is introduced to site of a living subject, such as a mammal, e.g., a human. The site may be an external or internal site. Internal sites of interest include, but are not limited to: bone repair sites, such as reduced fracture voids, bone voids resulting from removal of damaged or necrotic bone, etc. The amount which is introduced may vary depending on a particular application, but may in some instances range from 0.5 to 50 cc, such as 1 to 30 cc, including 5 to 25 cc.

Where desired, the granules may be complexed with an active agent, where the active agent may, in the broadest sense, be an inorganic or organic active agent. Active agents of interest include, but are not limited to: organic polymers, e.g., proteins, including bone associated proteins which impart a number of properties, such as enhancing resorption, angiogenesis, cell entry and proliferation, mineralization, bone formation, growth of osteoclasts and/or osteoblasts, and the like, where specific proteins of interest include, but are not limited to: osteonectin, bone sialoproteins (Bsp), α-2HS-glycoproteins, bone Gla-protein (Bgp), matrix Gla-protein, bone phosphoglycoprotein, bone phosphoprotein, bone proteoglycan, protolipids, bone morphogenic protein, cartilage induction factor, platelet derived growth factor, skeletal growth factor, and the like; particulate extenders; inorganic water soluble salts, e.g., NaCl, calcium sulfate; sugars, e.g., sucrose, fructose and glucose; pharmaceutically active agents, e.g., antibiotics; and the like. Of particular interest in certain embodiments are formulations that include the presence of one or more osteoinductive agents, including, but not limited to, those listed above. Additional active agents of interest include osteoclast induction agents, e.g., RANKL, as described in U.S. Pat. No. 7,252,833, the disclosure of which is herein incorporated by reference.

In some instances, an angiogenic factor is combined with the dry reactants and setting fluid, so that the flowable composition includes an amount of an angiogenic growth factor. As used herein, an “angiogenic growth factor polypeptide” refers to any protein, polypeptide, mutein or portion that is capable of inducing endothelial cell growth.

Angiogenic growth factors of interest include, but are not limited to: vascular endothelial cell growth factors (VEGF), acidic fibroblast growth factor (aFGF), basic fibroblast growth factor (bFGF), FGF2, epidermal growth factor, transforming growth factors α and β, platelet-derived endothelial growth factor, platelet-derived growth factor, tumor necrosis factor α, hepatocyte growth factor (scatter factor), erythropoietin, colony stimulating factor (CSF), macrophage-CSF (M-CSF), granulocyte/macrophage CSF (GM-CSF), angiopoietin 1 and 2, and nitric oxide synthase (NOS). The nucleic acid and amino acid sequences for these and other angiogenic growth factors are available in public databases such as GenBank and in the literature.

In some instance, the angiogenic growth factor is a VEGF, where VEGF proteins of interest include, but are not limited to: VEGF 1 (also referred to as VEGF A); VEGF 2 (also referred to as VEGF C); VEGF B; and VEGF D), PGF, etc. In addition to the above angiogenic growth factors, also of interest are their homologs and alleles and functionally equivalent fragments or variants thereof. For example, human VEGF 1 (VEGF A) exists in four principal isoforms, phVEGF₁₂₁; phVEGF₁₄₅; phVEGF₁₆₅; and phVEGF₁₈₉. Also of interest are the VEGF proteins and mutants thereof described in U.S. Pat. Nos. 5,851,989; 5,972,338; 057,428; 6,258,560; 6,348,351; 6,350,450; 6,368,853; 6,391,311; 6,395,707; 6,451,764; 6,455,496; 6,492,331; 6,551,822; 6,576,608; 6,586,397; 6,620,784; 6,750,044; 6,897,294; 6,927,024; 7,005,505; 7,060,278; 7,090,834; 7,208,472; 7,323,553; 7,427,596; 7,446,168; 7,494,977; 7,632,810; 7,651,703; 7,700,571; 7,709,455; 7,727,536; 7,785,588.

In addition, in certain embodiments the compositions include an organic agent that is a xenogeneic, allogeneic or autologous organic component. For example, demineralized bone matrix, which may be obtained typically in a lyophilized or gel form, may be combined with the granule composition at some point prior to implantation. A variety of demineralized bone matrixes are known to those of skill in the art and any convenient/suitable matrix composition may be employed.

In certain embodiments, the granule compositions may be complexed with any of a variety of cells, as described in published U.S. Patent Publication No. 20020098245, the disclosure of which is herein incorporated by reference in its entirety. A “cell”, according to the present invention, is any preparation of living tissue, including primary tissue explants and preparations thereof, isolated cells, cells lines (including transformed cells), and host cells. Where desired, autologous cells are employed, but xenogeneic, allogeneic, or syngeneic cells are also useful. As such, the cells can be obtained directly from a mammalian donor, e.g., a patient's own cells, from a culture of cells from a donor, or from established cell culture lines. The mammal can be a mouse, rat, rabbit, guinea pig, hamster, cow, pig, horse, goat, sheep, dog, cat, and the mammal can be a human. Cells of the same species and preferably of the same immunological profile can be obtained by biopsy, either from the patient or a close relative. Where the cells are not autologous, it may be desirable to administer immunosuppressive agents in order to minimize rejection. In preferred embodiments, such agents may be included within the seeded composition to ensure effective local concentrations of the agents and to minimize systemic effects of their administration. The cells employed may be primary cells, explants, or cell lines, and may be dividing or non-dividing cells. Cells may be expanded ex-vivo prior to introduction into the inventive bone void filler compositions. Autologous cells are preferably expanded in this way if a sufficient number of viable cells cannot be harvested from the host. Any preparation of living cells may be used. For example, cultured cells or isolated individual cells may be used. Alternatively or additionally, pieces of tissue, including tissue that has some internal structure, may be used. The cells may be primary tissue explants and preparations thereof, cell lines (including transformed cells), or host cells. Any available methods may be employed to harvest, maintain, expand, and prepare cells for use in the present invention. Useful references that describe such procedures include, for example, Freshney, Culture of Animal Cells: a Manual of Basic Technique, Alan R. Liss Inc., New York, N.Y., incorporated herein by reference.

In some instances, the porous calcium phosphate granules are combined with an autologous or allogeneic composition. The composition with which the granules may be combined can be a number of substances that render the porous material bioactive including, but not limited to, biological materials such as bone marrow, whole blood, plasma or other blood components or growth factors. Bone marrow aspirate (BMA) is a complex tissue comprised of cellular components (that contribute to bone growth) including red and white blood cells, their precursors and a connective tissue network termed the stroma. Bone marrow stromal cells or mesenchymal stem cells have the potential to differentiate into a variety of identifiable cell types including osteoblasts, fibroblasts, endothelial cells, reticulocytes, adipocytes, myoblasts and marrow stroma. Consequently, bone marrow aspirate is a good source of osteogenic cells for immediate transplantation. For subsequent use in transplantation, stem cells can also be cultured and expanded many times to increase their original number. Stromal cells regulate the differentiation of hematopoietic cells through cell-surface protein interactions and secretion of growth factors. Bone marrow may be used to stimulate bone healing in many applications providing a promptly renewable, reliable source of osteogen c cells. BMA may also provide osteogenic components, namely the progenitors of osteoblasts. Where employed, BMA may be harvested using any convenient protocol.

The porous calcium phosphate granule compositions may be provided as a granular composition, or a shaped article, e.g., of adhered or fused granules. Where shaped, the composition may be provided in any basic shape, including cylinders, blocks, strips, sheets, and wedges. In one embodiment, the granules are provided in basic cylinder or strip form. In other embodiments, the granules may have a finite shape or custom shape for specific applications (e.g., semi-spherical for graft acetabular containment, half-tubular long bone wrap or sleeve), or may be “shredded” and housed within a delivery vessel. Some basic shapes may be a disk, semi-sphere, semi-tubular, or torus. Shaped articles may be provided from the granules using any convenient protocol. In some instances, the granules are fused into a desired shape, e.g., by placing the granules in a suitable mold and then subjecting the granules to sintering conditions, such as described above. Shaped articles may also be provided by use of a suitable binding agent, e.g., by placing the granules in a mold with a suitable binding agent, such as a polymeric physiologically compatible binding agent. Yet, in other embodiments, the granules may serve as a coating on any orthopedic appliance such as an intermedullary rod, pedicle screw, plate, hip stem, acetabular cup component and the like.

Compositions as described herein find utility in a wide variety of applications and in some instances provide an alternative to autografts, or implantation materials comprised of cadaver bone, bovine bone, or the like. The granular compositions, whether or not complexed with another component, can be used in medicine, such as, but not limited to, the restoration of bony defects. The materials can also be used for the delivery of medicaments that are internal to the defect. In this way, the pores of the granular composition can be partially filled with another material which either comprises or carries a medicament such as a growth hormone, antibiotic, cell signaling material, or the like. The larger porous spaces within some of the products of the present invention can be used for the culturing of cells within the human body. In this regard, the larger spaces are amenable to the growth of cells and can be permeated readily by bodily fluids such as certain blood components. In this way, growing cells can be implanted in an animal through the aegis of implants in accordance with the present invention. These implants can give rise to important biochemical or therapeutic or other uses. Additional applications in which the present compositions find use include, but are not limited to, those described in U.S. Pat. Nos. 7,189,263; 7,052,517; 7,045,125; and 6,736,799.

### Kits

Also provided are kits that include the granular compositions of porous calcium phosphate granules, e.g., as described above. Where desired, the kits may further include one or more additional components, e.g., active agents as described above. In some instances, the kits will include a device configured for combining the composition with autologous material. An example of such a device is a container configured to house an amount of porous granules and an inlet configured to receive an amount of autologous material, e.g., BMA. In some instances, the kit may further include a device for harvesting autologous material from a subject (e.g., a syringe), wherein the device is configured to operatively couple to the device for combining the composition with the autologous material. Examples of such devices are described in U.S. Pat. Nos. 7,052,517 and 6,736,799; the disclosures of which patents are herein incorporated by reference.

In addition to above-mentioned components, the subject kits may further include instructions for using the components of the kit to practice the subject methods. The instructional material may also be instructional material for using the granule composition, e.g., it may provide surgical techniques and principals for a particular application in which the granules is to be employed. The instructions for practicing the subject methods are generally recorded on a suitable recording medium. For example, the instructions may be printed on a substrate, such as paper or plastic, etc. As such, the instructions may be present in the kits as a package insert, in the labeling of the container of the kit or components thereof (i.e., associated with the packaging or sub-packaging) etc. In other embodiments, the instructions are present as an electronic storage data file present on a suitable computer readable storage medium, e.g. CD-ROM, diskette, etc. In yet other embodiments, the actual instructions are not present in the kit, but means for obtaining the instructions from a remote source, e.g. via the internet, are provided. An example of this embodiment is a kit that includes a web address where the instructions can be viewed and/or from which the instructions can be downloaded. As with the instructions, this means for obtaining the instructions is recorded on a suitable substrate.

Aspects of the invention are further provided in the following clauses:
1. A method of making a spherical porous calcium phosphate granule, the method comprising:

(a) producing a solid spherical granule precursor comprising:
(i) a calcium phosphate component; and
(ii) a porogen component; and

(b) removing the porogen component from the solid spherical granule precursor to produce a spherical porous calcium phosphate granule.

2. The method according to Clause 1, wherein the solid spherical granule precursor is produced by:

combining a calcium phosphate powder, a porogen and a liquid vehicle to produce a liquid precursor composition; and

making a solid spherical granule precursor from the liquid precursor composition.

3. The method according to Clause 2, wherein the solid spherical granule precursor is made by:

fabricating a droplet from the liquid precursor composition; and

solidifying the droplet.

4. The method according to Clause 3, wherein the liquid precursor composition includes a polymeric component and the droplet is solidified by insolubilizing the polymeric component.
5. The method according to Clause 4, wherein the polymeric component is insolubilized by contacting the droplet with an insolubilizing agent.
6. The method according to Clause 5, wherein the polymeric component is a water-soluble alginic salt and the insolubilizing agent is a salt of a divalent cation.
7. The method according to Clause 6, wherein the water-soluble alginic salt is sodium alginate and the divalent cation salt is a calcium salt.
8. The method according to any of the preceding clauses, wherein the calcium phosphate component comprises a particulate composition of a tricalcium phosphate, a hydroxyapatite and combinations thereof.
9. The method according to any of the preceding clauses, wherein the particulate composition comprises β-tricalcium phosphate.
10. The method according to any of the preceding clauses, wherein the porogen component comprises a porogen particulate composition.
11. The method according to any of the preceding clauses, wherein the spherical porous calcium phosphate granule comprises a substantially pure calcium phosphate selected from the group consisting of β-tricalcium phosphate and hydroxyapatite.
12. The method according to any of the preceding clauses, wherein the spherical porous calcium phosphate granule has a porosity ranging from 70 to 90%.
13. The method according to any of the preceding clauses, wherein the spherical porous calcium phosphate granule comprises macropores and micropores.
14. The method according to any of the preceding clauses, wherein the spherical porous calcium phosphate granule has a diameter ranging from 2 to 3 mm.
15. The method according to any of the preceding clauses, wherein the spherical porous calcium phosphate granule has a surface area of 1 m²/g or less.
16. The method according to any of the preceding clauses, wherein the method further comprises complexing the granule with an active agent.
17. A substantially pure spherical porous calcium phosphate granule having a porosity ranging from 70 to 90%.
18. The spherical porous calcium phosphate granule according to Clause 17, wherein the granule comprises a substantially pure calcium phosphate selected from the group consisting of β-tricalcium phosphate and hydroxyapatite.
19. The spherical porous calcium phosphate granule according to Clause 17 or 18, wherein the granule comprises macropores and micropores.
20. The spherical porous calcium phosphate granule according to Clauses 17, 18 or 19, wherein the granule has a diameter ranging from 2 to 3 mm.
21. The spherical porous calcium phosphate granule according to any of the preceding clauses 17 to 20, wherein the granule has a surface area of 1 m²/g or less.
22. The spherical porous calcium phosphate granule according to any of the preceding clauses 17 to 21, wherein the granule is complexed with an active agent.
23. A composition comprising a plurality of substantially pure spherical porous calcium phosphate granules of narrow size distribution.
24. The composition according to Clause 23, wherein the composition comprises 100 or more granules.
25. The composition according to Clauses 23 or 24, wherein the granules have a porosity ranging from 70 to 90%.
26. The composition according to any of the preceding clauses 23 to 25, wherein the granules comprise a substantially pure calcium phosphate selected from the group consisting of β-tricalcium phosphate and hydroxyapatite.
27. The composition according to any of the preceding clauses 23 to 26, wherein the granules comprise macropores and micropores.
28. The composition according to any of the preceding clauses 23 to 27, wherein the granules have a diameter ranging from 2 to 3 mm.
29. The composition according to any of the preceding clauses 23 to 28, wherein the granules have a surface area of 1 m²/g or less.
30. The composition according to any of the preceding clauses 23 to 29, wherein the granules are complexed with an active agent.
28. A method comprising introducing to site of a living subject a composition comprising a plurality of substantially pure spherical porous calcium phosphate granules of narrow size distribution.
29. The method according to Clause 28, wherein the site is an internal body site.
30. The method according to Clause 29, wherein the internal body site is a bone repair site.
31. The method according to Clause 28, 29 or 30, wherein the composition granules are complexed with an active agent.
32. The method according to any of the preceding clauses 28 to 31, wherein the granules are complexed with an organic agent.
33. The method according to Clause 32, wherein the organic agent is a xenogeneic, allogeneic or autologous organic component.
34. The method according to Clause 33, wherein the organic agent is an autologous component.
35. The method according to Clause 34, wherein the method further comprises harvesting the autologous component.
36. The method according to Clause 35, wherein the autologous component is a blood or marrow derived component.
37. A shaped object comprising a fused plurality of substantially pure spherical porous calcium phosphate granules of narrow size distribution.
38. The shaped object according to Clause 37, wherein the body comprises 100 or more granules.
39. The shaped object according to Clauses 37 or 38, wherein the granules have a porosity ranging from 70 to 90%.
40. The shaped object according to Clause 37, 38 or 39, wherein the granules comprise a substantially pure calcium phosphate selected from the group consisting of β-tricalcium phosphate and hydroxyapatite.
41. The shaped object according to any of the preceding clauses 37 to 40, wherein the granules comprise macropores and micropores.
42. The shaped object according to any of the preceding clauses 37 to 41, wherein the granules have a diameter ranging from 2 to 3 mm.
43. The shaped object according to any of the preceding clauses 37 to 42, wherein the granules have a surface area of 1 m²/g or less.
44. The shaped object according to any of the preceding clauses 37 to 43, wherein the granules are complexed with an active agent.
45. A kit comprising:

(a) a composition comprising a plurality of substantially pure spherical porous calcium phosphate granules of narrow size distribution; and

(b) a device for combining the composition with autologous material.

46. The kit according to Clause 45, wherein the kit further comprises a device for harvesting autologous material from a subject, wherein the device is configured to operatively couple to the device for combining the composition with the autologous material.

The following examples are offered by way of illustration and not by way of limitation.

### EXPERIMENTAL

### I. Synthesis of β-TCP Granules

A 500 ml 1% sodium alginate solution was prepared by adding 5 grams of sodium alginate (Acros) to a 500 ml beaker and then adding 495 grams deionized water into the beaker. The beaker was then placed into a 37° C. oven and maintained overnight, yielding a clear solution the next morning. A 2.5 L 100 mM calcium chloride solution was prepared by adding 36.75 grams of calcium chloride to a 4 L beaker and filling the beaker with water to 2.5 kgs.

21 grams of Cultispher® macroporous gelatin beads (part number M9043, Sigma Aldrich) were combined with 128 grams of deionized water in a 250 ml beaker and mixed with a spatula in order to wet all of the Cultispher® beads. 40 grams of tricalcium phosphate (TCP) powder (Fluka, part number-21218) was combined with 400 grams of the 1% sodium alginate solution prepared as described above in a beaker and mixed using a paddle mixer for 2 minutes to homogenize the solution. To this TCP-alginate solution were added the soaked Cultispher® beads, followed by mixing using a paddle mixer for 5 minutes to homogenize the solution. A magnetic stir bar was placed in this solution and the beaker was placed on top of a stir plate, following by stirring of the solution.

β-TCP granules were made using a large scale set-up with an 11 gauge cannula, 10 psi, and air flow of 3.087 l/m. The granules were formed by dropping the sodium algniate solution into a 100 mM calcium chloride solution, and were maintained in the calcium chloride solution for 2 hours. The granules were then filtered using a sieve. The sieved granules were then washed by placing them back into a 4 L beaker and filling the beaker with 3 L deionized water, followed by stirring for 30 minutes and removal of the liquid. This washing step was repeated once.

The resultant granules were then sieved and lyophilized by freezing the granules using liquid nitrogen (and specifically by pouring liquid nitrogen on the granules and surrounding the container with liquid nitrogen for at least 10 minutes), followed by maintaining the frozen granules in a lyophilizer overnight.

The lyophilized granules were then placed in an alumina tray and sintered by placing the tray in the furnace hot-zone and following the below ramp cycle:

| | |
|---|---|
| Room temperature to 110° C. | 10 hours |
| 110° C. to 250° C. | 12 hours |
| 250° C. to 500° C. | 9 hours |
| 500° C. to 1300° C. | 9 hours |
| 1300° C. hold | 9 hours |
| 1300° C. to room temperature | 9 hours |

The final sintered granules were characterized as described below.

### II. Characterization

β-tricalcium phosphate granules produced as described in section I above were characterized using the following techniques: X-ray Diffraction (XRD); Fourier transformed infrared (FTIR) spectroscopy; Scanning Electron Microscopy (SEM); Surface area; Inductively-coupled plasma-atomic emission spectroscopy (ICP-AES); Porosimetry—Mercury-intrusion and nitrogen-intrusion.

### A. X-ray Diffraction (XRD)

### 1. Procedure:

Ground β-TCP granules and commercial β-TCP powder (Sigma-Aldrich, part # 49963) were used for XRD analysis. An Ultima IV powder X-ray diffractometer (Rikagu USA, The Woodlands, Tex.), operated at 40 kV and 44 mA, equipped with a Cu tube was utilized to collect X-ray diffraction patterns for these powder samples. X-ray diffraction data was collected for 2θ values of 10° to 40° with a step size of 0.02° 2θ and a preset time of 1 s at each step. The collected XRD patterns were then compared to the Powder Diffraction File #550898.

### 2. Results:

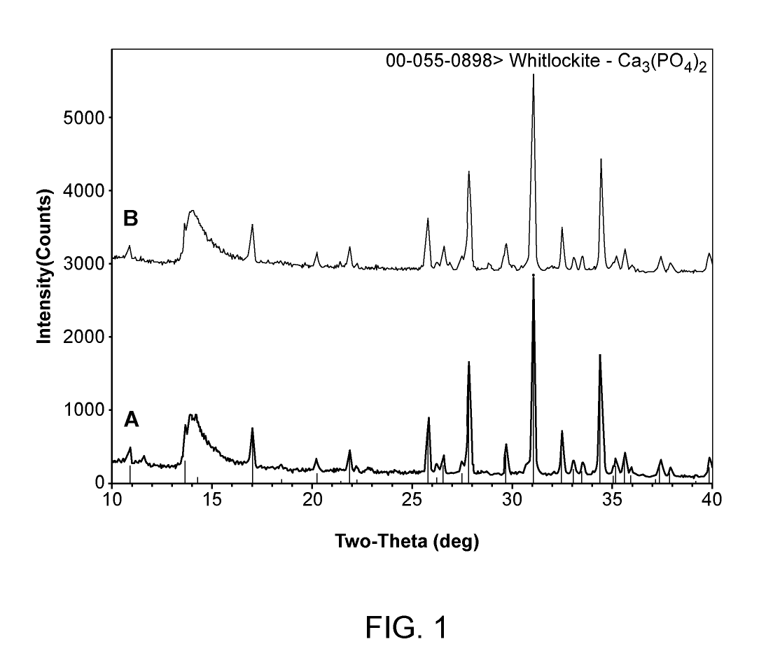

The XRD results are shown in FIG. 1, comparing the commercial β-TCP powder (FIG. 1a) with β-TCP granules synthesized as described above (FIG. 1b). The pattern shows that the synthesized granules are pure β-TCP. The ASTM standard requires the XRD to indicate a minimum of 95% β-TCP upon comparing to Powder Diffraction file # 550898. In addition to the above comparison with commercial β-TCP, the XRD pattern of the synthesized β-TCP granules presented in FIG. 1b was compared with the Powder diffraction file # 550898 and confirms phase purity. Accordingly, the β-TCP granules are phase pure.

### B. Fourier Transformed Infrared (FTIR) Spectroscopy

### 1. Procedure:

Ground β-TCP granules (produced as described above) and commercial β-TCP powder (Sigma-Aldrich, part # 49963) were used for FTIR analysis. Sample pellets were made by mixing 1 mg of the sample powder with 300 mg of dried spectroscopic grade KBr, and pressing in a vacuum die under a pressure of 1200 psi. The pellets were run on a FTIR machine (Nicolet iS10, Thermo-Nicolet, Woburn, Mass.) at 256 scans at a typical resolution of 4 cm⁻¹.

### 2. Results:

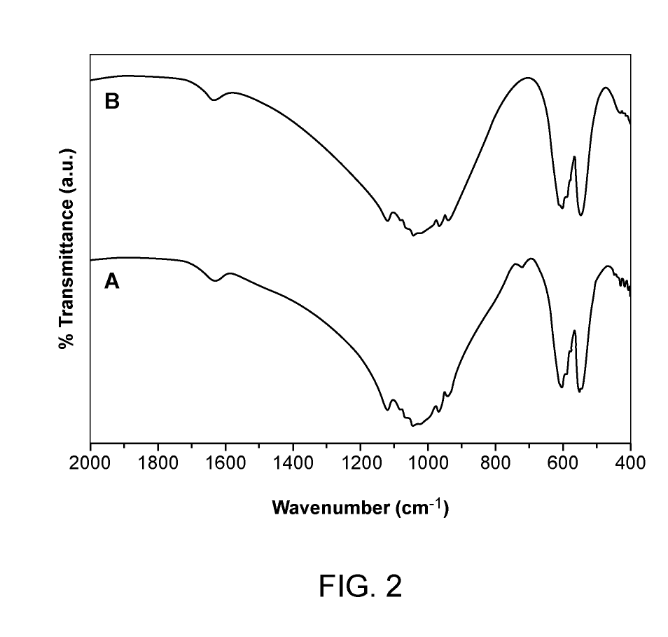

The comparison of FTIR patterns between the commercial β-TCP powders with the β-TCP granules synthesized as described above is shown in FIG. 2. The FTIR patterns for both materials, commercial and synthesized β-TCP granules, match with each other and to the characteristic FTIR bands for β-TCP (1A. Jillavenkatesa and R. A. Condrate Sr., “The Infrared and Raman Spectra of β- and α-Tricalcium Phosphate (Ca₃(PO₄)₂),” Spectroscopy Letters, 31:8, 1619-1634) as shown in Table 1.

TABLE 1
IR band comparisons for commercial β-TCP powder and in-house
synthesized β-TOP granules with characteristic IR bands of β-TCP

| | Wavenumber (cm⁻¹) | | |
|---|---|---|---|
| | Commercial | In-house | |
| | β-TCP | synthesized β-TCP | Characteristic IR |
| | powders | granules | bands for β-TCP |
| absorbed H₂O | 1630 | 1634 | — |
| PO₄³⁻ V₃ | 1120 | 1120 | 1120 |
| PO₄³⁻ V₃ | 1043 | 1043 | 1042 |
| PO₄³⁻ V₃ | 1023 | 1023 | 1025 |
| PO₄³⁻ V₁ | 969 | 967 | 972 |
| PO₄³⁻ V₁ | 943 | 939 | 945 |
| CO₃²⁻ | 721 | — | — |
| PO₄³⁻ V₄ | 605 | 605 | 606 |
| PO₄³⁻ V₄ | 591 | 591 | 594 |
| PO₄³⁻ V₄ | 552 | 549 | 552 |

### C. Scanning Electron Microscopy (SEM)

### 1. Procedure:

Surface morphology of the sputter-coated (w/Pt) β-TCP granules (pristine and cracked) was evaluated with a scanning electron microscope (FE-SEM; FEI Quanta 650)) which was used in the secondary electron (SE) mode with an acceleration voltage of 10 kV.

### 2. Results:

The SEM micrographs (FIG. 3) show the porosity of the prepared granules. FIGS. 3a and 3b demonstrate the bead outer morphology and porosity. The granules from outside have very little macro-porosity but are highly micro-porous. In FIGS. 3c and 3d, the cracked surface of the granules is analyzed. The inside of the granules is highly macro- and micro-porous, where the macro- and micropores are homogeneously distributed along the inside of the granules (FIGS. 3e and 3f).

### D. Surface Area

### 1. Procedure:

The BET surface area of the β-TCP granules was determined by applying the standard Brunnauer-Emmet-Teller method to the nitrogen adsorption isotherms obtained at −196° C. using a Micromeritics Gemini 2365 instrument (Norcross, Ga.). Nitrogen adsorption-desorption isotherms were measured at relative pressures between 10⁻² and 1.

### 2. Results:

The BET method showed the surface area to be below 1 m²/gram. Surface area for β-TCP granules was found to be 0.24 m²/g.

### D. Inductively Coupled Plasma-Mass Spectroscopy (ICP-MS)

### 1. Procedure:

Chemical analyses of β-TCP granules were performed by ICP-MS, the granules were ground before use. Samples were prepared with 0.2 g weighed portions mixed with 30 mL water, 1 mL nitric acid, 3 mL hydrochloric acid and internal standard solution (the material dissolved); dilution to 100 g produced solutions for ICPMS analysis. Duplicate tests were run for the sample in order to confirm the prior results.

2. Results:

The ASTM standard suggests a limit to heavy metals/trace elements presence as mentioned in Table 2 below.

TABLE 2
Limit of heavy metal/trace elements in β-TCP vs. present
in β-TCP granules

| Element | | |
|---|---|---|
| Other Metals | ppm, max | β-TCP granules (ppm) |
| Pb | 30 | 0.81 |
| Hg | 5 | ND |
| As | 3 | ND |
| Cd | 5 | ND |

*ND—Not Detected

The β-TCP granules correspond to the ASTM standard as shown in Table 2.

### E. Mercury-Intrusion Porosimetry:

### 1. Procedure:

In the mercury intrusion porosimetry experiment, liquid mercury was injected into the sintered rectangular pieces at various pressures and total porosity values were determined by using the below formula(s):

Vₚ=(injected mercury volume at 50 atm−correction factor at 50 atm.)×1.02

Total porosity=(Vₚ/V_{b})×100,

where Vₚ is the pore volume and V_{b} is the bulk volume.

### 2. Results:

The porosimetry data shows that the beads are 80% porous.

All publications and patent applications mentioned in this specification are herein incorporated by reference to the same extent as if each individual publication or patent application was specifically and individually indicated to be incorporated by reference.

The invention now being fully described, it will be apparent to one of skill in the art that many changes and modifications can be made thereto without departing from the spirit and scope of the appended claims.

1. A method of making a spherical porous calcium phosphate granule, the method comprising:
(a) producing a solid spherical granule precursor comprising:
(i) a calcium phosphate component; and
(ii) a porogen component; and
(b) removing the porogen component from the solid spherical granule precursor to produce a spherical porous calcium phosphate granule.

2. The method according to claim 1, wherein the solid spherical granule precursor is produced by:
combining a calcium phosphate powder, a porogen and a liquid vehicle to produce a liquid precursor composition; and
making a solid spherical granule precursor from the liquid precursor composition.

3. The method according to claim 2, wherein the solid spherical granule precursor is made by:
fabricating a droplet from the liquid precursor composition; and
solidifying the droplet.

4. The method according to claim 3, wherein the liquid precursor composition includes a polymeric component and the droplet is solidified by insolubilizing the polymeric component.

5. The method according to claim 4, wherein the polymeric component is insolubilized by contacting the droplet with an insolubilizing agent.

6. The method according to claim 5, wherein the polymeric component is a water-soluble alginic salt and the insolubilizing agent is a salt of a divalent cation.

7. The method according to claim 6, wherein the water-soluble alginic salt is sodium alginate and the divalent cation salt is a calcium salt.

8. The method according to claim 1, wherein the calcium phosphate component comprises a particulate composition of a tricalcium phosphate, a hydroxyapatite and combinations thereof.

9. The method according to claim 1, wherein the particulate composition comprises β-tricalcium phosphate.

10. The method according to claim 1, wherein the porogen component comprises a porogen particulate composition.

11. The method according to claim 1, wherein the spherical porous calcium phosphate granule comprises a substantially pure calcium phosphate selected from the group consisting of β-tricalcium phosphate and hydroxyapatite.

12. The method according to claim 1, wherein the spherical porous calcium phosphate granule has a porosity ranging from 70 to 90%.

13. The method according to claim 1, wherein the spherical porous calcium phosphate granule comprises macropores and micropores.

14. The method according to claim 1, wherein the spherical porous calcium phosphate granule has a diameter ranging from 2 to 3 mm.

15. The method according to claim 1, wherein the spherical porous calcium phosphate granule has a surface area of 1 m²/g or less.

16. The method according to claim 1, wherein the method further comprises complexing the granule with an active agent.

17. A substantially pure spherical porous calcium phosphate granule having a porosity ranging from 70 to 90%.

18. The spherical porous calcium phosphate granule according to claim 17, wherein the granule comprises a substantially pure calcium phosphate selected from the group consisting of β-tricalcium phosphate and hydroxyapatite.

19. The spherical porous calcium phosphate granule according to claim 17, wherein the granule comprises macropores and micropores.

20-44. (canceled)

45. A kit comprising:
(a) a composition comprising a plurality of substantially pure spherical porous calcium phosphate granules of narrow size distribution; and
(b) a device for combining the composition with autologous material.

46. (canceled)
